(19) United States
(12) Patent Application Publication
(10) Pub. No.: US 2025/0150799 A1
(43) Pub. Date: May 8, 2025

(54) ELECTRONIC DEVICE FOR MANAGING EMERGENCY ALERT MESSAGE AND METHOD OF OPERATING THE SAME

(71) Applicant: Electronics and Telecommunications Research Institute, Daejeon (KR)

(72) Inventors: Hyunjoo KANG, Daejeon (KR); Seung-Hee OH, Daejeon (KR); SANG LIM JU, Daejeon (KR)

(21) Appl. No.: 18/739,157

(22) Filed: Jun. 10, 2024

(30) Foreign Application Priority Data
Nov. 7, 2023 (KR) 10-2023-0152694

(51) Int. Cl. H04W 4/90; H04W 4/021

(52) U.S. Cl. CPC H04W 4/90; H04W 4/021

(57) ABSTRACT

An electronic device for managing an emergency alert message and a method of operating the same are provided. The method includes receiving an emergency alert message transmission request from a server, in response to the emergency alert message transmission request, transmitting, to a mobile communication network gateway, a request message for requesting a base station to transmit an emergency alert message to a terminal, and transmitting, to the mobile communication network gateway, a trigger request message for causing the base station to repeatedly transmit a trigger message to the terminal to attempt to display the emergency alert message on a screen of the terminal, wherein the emergency alert message transmission request may include geo-fence information, transmission period information of the trigger message, and transmission number information of the trigger message.

### CROSS-REFERENCE TO RELATED APPLICATION

This application claims the benefit of Korean Patent Application No. 10-2023-0152694, filed on Nov. 7, 2023, in the Korean Intellectual Property Office, the entire disclosure of which is incorporated herein by reference for all purposes.

### BACKGROUND

### 1. Field of the Invention

One or more embodiments relate to an electronic device for managing an emergency alert message and a method of operating the same.

### 2. Description of the Related Art

In order to quickly inform the public of emergency situations, the country operates a service for transmitting emergency alert messages to unspecified individuals using a cell broadcast function of mobile communication networks. However, in a process of specifying an area to receive the emergency alert messages, the emergency alert messages may be transmitted to a wider area than expected.

For example, when a forest fire occurs over a wide area, the spreading direction and speed of the forest fire may change depending on the direction of the wind and formation of trees. In other words, it may be difficult to specify the scope of the disaster. Therefore, in order to protect the lives and property of people, the government transmits emergency alert messages to disaster areas to inform people of the occurrence of the disaster, the progress direction of the disaster, and the evacuation location of the disaster.

### SUMMARY

Embodiments provide an electronic device for providing an emergency alert message using geo-fencing technology and a method of operating the same.

Embodiments provide an electronic device for displaying a stored emergency alert message on a screen when a terminal enters a disaster zone using a trigger message and a method of operating the same.

According to an aspect, there is provided a method of operating an electronic device, the method including receiving an emergency alert message transmission request from a server, in response to the emergency alert message transmission request, transmitting, to a mobile communication network gateway, a request message for requesting a base station to transmit an emergency alert message to a terminal, and transmitting, to the mobile communication network gateway, a trigger request message for causing the base station to repeatedly transmit a trigger message to the terminal to attempt to display the emergency alert message on a screen of the terminal, wherein the emergency alert message transmission request may include geo-fence information, transmission period information of the trigger message, and transmission number information of the trigger message.

The transmitting of the request message to the mobile communication network gateway may include converting an area code value included in the emergency alert message transmission request into a transmission area value of a mobile communication service provider, based on mapping information requested by the mobile communication service provider, and determining whether an emergency alert message display area exists in a transmission area corresponding to the transmission area value.

The transmitting of the trigger request message to the mobile communication network gateway may include, when the emergency alert message display area does not exist, not transmitting the trigger request message to the mobile communication network gateway.

The transmitting of the request message to the mobile communication network gateway may further include determining whether the emergency alert message transmission request includes the transmission period information of the trigger message and the transmission number information of the trigger message.

The transmitting of the trigger request message to the mobile communication network gateway may include, when the emergency alert message transmission request does not include at least one of the transmission period information of the trigger message or the transmission number information of the trigger message, not transmitting the trigger request message to the mobile communication network gateway.

The terminal may not display the emergency alert message on the screen of the terminal, when the terminal is located within an emergency alert message transmission area but not within an emergency alert message display area.

When the emergency alert message is received, even if the terminal is located within the emergency alert message transmission area but not within the emergency alert message display area, the terminal may display the emergency alert message on the screen of the terminal when the terminal is located within the emergency alert message display area when the trigger message is received.

The base station may repeatedly transmit the trigger message to the terminal based on the transmission period information of the trigger message and the transmission number information of the trigger message.

According to another aspect, there is provided a method of operating a terminal, the method including receiving an emergency alert message from a base station, determining whether to display the emergency alert message on a screen based on an emergency alert message display area included in the emergency alert message, and determining whether to display the emergency alert message on the screen by repeatedly receiving a trigger message from the base station, wherein the base station may transmit, to the terminal, the emergency alert message transmitted from an electronic device that has received an emergency alert message transmission request to the terminal, and wherein the emergency alert message transmission request may include geo-fence information, transmission period information of the trigger message, and transmission number information of the trigger message.

The determining of whether to display the emergency alert message on a screen based on an emergency alert message display area included in the emergency alert message may include, when the terminal is located within an emergency alert message transmission area but not within an emergency alert message display area, not displaying the emergency alert message on the screen of the terminal.

The determining of whether to display the emergency alert message on the screen by repeatedly receiving a trigger message from the base station may include, when the emergency alert message is received, even if the terminal is located within the emergency alert message transmission area but not within the emergency alert message display area, displaying the emergency alert message on the screen of the terminal when the terminal is located within the emergency alert message display area when the trigger message is received.

According to another aspect, there is provided an electronic device including a memory and a processor, wherein the processor may be configured to receive an emergency alert message transmission request from a server, in response to the emergency alert message transmission request, transmit, to a mobile communication network gateway, a request message for requesting a base station to transmit an emergency alert message to a terminal, and transmit, to the mobile communication network gateway, a trigger request message for causing the base station to repeatedly transmit a trigger message to the terminal to attempt to display the emergency alert message on a screen of the terminal, wherein the emergency alert message transmission request may include geo-fence information, transmission period information of the trigger message, and transmission number information of the trigger message.

The processor may be further configured to convert an area code value included in the emergency alert message transmission request into a transmission area value of a mobile communication service provider, based on mapping information requested by the mobile communication service provider, and determine whether an emergency alert message display area exists in a transmission area corresponding to the transmission area value.

The processor may be further configured not to transmit the trigger request message to the mobile communication network gateway when the emergency alert message display area does not exist.

The processor may be further configured to determine whether the emergency alert message transmission request includes the transmission period information of the trigger message and the transmission number information of the trigger message.

The processor may be further configured not to transmit the trigger request message to the mobile communication network gateway when the emergency alert message transmission request does not include at least one of the transmission period information of the trigger message or the transmission number information of the trigger message.

The terminal may not display the emergency alert message on the screen of the terminal, when the terminal is located within an emergency alert message transmission area but not within an emergency alert message display area.

When the emergency alert message is received, even if the terminal is located within the emergency alert message transmission area but not within the emergency alert message display area, the terminal may display the emergency alert message on the screen of the terminal when the terminal is located within the emergency alert message display area when the trigger message is received.

The base station may repeatedly transmit the trigger message to the terminal based on the transmission period information of the trigger message and the transmission number information of the trigger message.

Additional aspects of embodiments will be set forth in part in the description which follows and, in part, will be apparent from the description, or may be learned by practice of the disclosure.

According to embodiments, an emergency alert message transmission area is distinguished from an emergency alert message area using geo-fencing technology, and thus, a terminal that has displayed an emergency alert message once may not receive the same message repeatedly.

According to embodiments, when a terminal, which has received an emergency alert message but has not displayed the emergency alert message, enters a disaster zone, the terminal may display the stored emergency alert message on a screen.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating devices for providing an emergency alert message according to an embodiment;

FIG. 2 is a flowchart illustrating communication between devices according to an embodiment;

FIG. 3 is a diagram illustrating an emergency alert message transmission area and an emergency alert message display area according to an embodiment; and

FIGS. 4 and 5 are flowcharts illustrating a method of operating an electronic device, according to an embodiment.

### DETAILED DESCRIPTION

Hereinafter, embodiments will be described in detail with reference to the accompanying drawings. The scope of the right, however, should not be construed as limited to the embodiments set forth herein. In the drawings, like reference numerals are used for like elements.

Various modifications may be made to the embodiments. Here, the embodiments are not construed as limited to the disclosure and should be understood to include all changes, equivalents, and replacements within the idea and the technical scope of the disclosure.

Although terms such as “first” or “second” are used to explain various components, the components are not limited to the terms. These terms should be used only to distinguish one component from another component. For example, a first component may be referred to as a second component, and similarly the second component may also be referred to as the first component.

The terminology used herein is for the purpose of describing particular embodiments only and is not intended to limit the embodiments. As used herein, the singular forms “a”, “an”, and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

Hereinafter, embodiments will be described in detail with reference to the accompanying drawings.

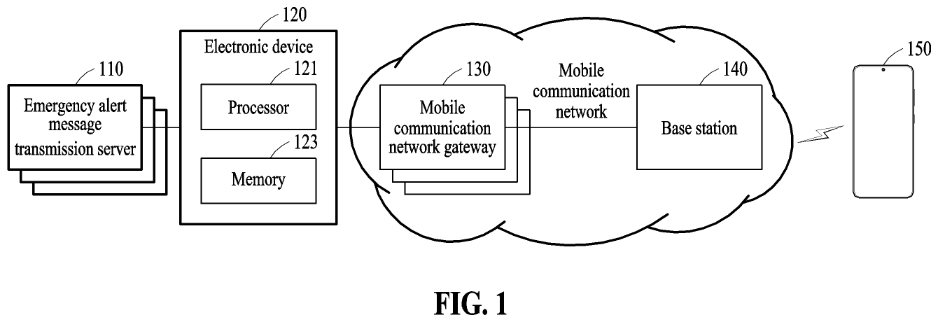

FIG. 1 is a diagram illustrating devices for providing an emergency alert message according to an embodiment.

Referring to FIG. 1, an emergency alert message transmission server 110, an electronic device 120, a mobile communication network gateway 130, a base station 140, and a terminal 150 are shown.

The emergency alert message transmission server 110 may classify disaster types into emergency, urgent, and safety guidance based on urgency. The emergency alert message transmission server 110 may request the electronic device 120 to transmit an emergency alert message according to the classified disaster type. The emergency alert message transmission server 110 may select an area to transmit the emergency alert message on an administrative district basis. The emergency alert message transmission server 110 may transmit the emergency alert message by selecting at least one unit of city, province, county, borough, district, town, and township. There may be a plurality of emergency alert message transmission servers 110 depending on a management organization.

The electronic device 120 may connect at least one emergency alert message transmission server 110 to a plurality of mobile communication network gateways 130. The electronic device 120 may be a relay server that relays the emergency alert message transmission server 110 and the plurality of mobile communication network gateways 130. The electronic device 120 may be referred to as a disaster communication integrated gateway. The electronic device 120 may be a device for synchronizing local information and transmitting emergency alert messages. The main function of the electronic device 120 may be processing emergency alert messages.

The electronic device 120 may include a processor 121 and a memory 123. In the example of FIG. 1, only the components related to the example described herein are illustrated in the electronic device 120. Thus, the electronic device 120 may also include other general-purpose components, in addition to the components illustrated in FIG. 1.

The processor 121 may perform overall functions for controlling the electronic device 120. The processor 121 may generally control the electronic device 120 by executing programs and/or instructions stored in the memory 123. The processor 121 may be implemented as a central processing unit (CPU), a graphics processing unit (GPU), an application processor (AP), and the like that are included in the electronic device 120, however, examples are not limited thereto. For example, the electronic device 120 may control the transmission of emergency alert messages.

The memory 123 may be hardware for storing data processed and data to be processed by the electronic device 120. In addition, the memory 123 may store an application, a driver, and the like to be driven by the electronic device 120. The memory 123 may include a volatile memory (e.g., dynamic random-access memory (DRAM)) and/or a non-volatile memory. For example, the electronic device 120 may store, in the memory 123, data such as emergency alert message transmission history and utilization information for each type of disasters.

The mobile communication network gateway 130 may be a device of a mobile communication service provider that processes emergency alert messages. Each mobile communication service provider may build a separate mobile communication network gateway 130. The mobile communication network gateway 130 may determine the base station 140 for transmitting an emergency alert message using administrative district information corresponding to an area where the emergency alert message is transmitted. The mobile communication network gateway 130 may be a commercial network operated by a mobile communication service provider.

The base station 140 may be connected to the mobile communication network gateway 130 with a mobile communication network. The base station 140 may be an end device in the mobile communication network that provides wireless network services which a terminal 150 accesses. The base station 140 may transmit an emergency alert message to the terminal 150 through a cell broadcast.

The terminal 150 may include a communication module for communicating with the base station 140. When the terminal 150 receives an emergency alert message, the terminal 150 may determine whether the emergency alert message is duplicated. When the emergency alert message is received, the terminal 150 may check location information of the terminal 150 and may determine whether to display the emergency alert message on a screen. The terminal 150 may be available for location services such as a global positioning system (GPS). When the terminal 150 that does not provide location services receives the emergency alert message, the terminal 150 may unconditionally display the emergency alert message on the screen.

Hereinafter, communication between each device is described.

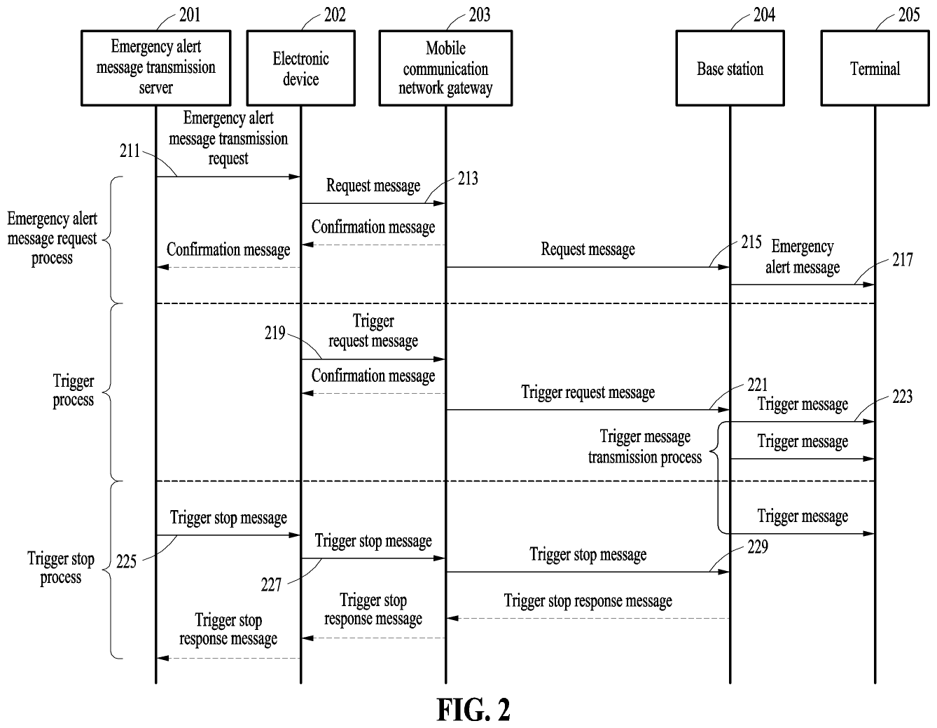

FIG. 2 is a flowchart illustrating communication between devices according to an embodiment.

Operations to be described hereinafter may be performed sequentially but not necessarily. For example, the order of the operations may change and at least two of the operations may be performed in parallel. Operations may be performed by any one of components of an electronic device.

In operation 211, an emergency alert message transmission server 201 may transmit an emergency alert message transmission request to an electronic device 202.

The emergency alert message transmission request may include geo-fence information.

The emergency alert message transmission request may include transmission period information of a trigger message and transmission number information of the trigger message.

In operation 213, the electronic device 202 may transmit, to a mobile communication network gateway 203, a request message for a base station 204 to transmit an emergency alert message to a terminal 205. The emergency alert message may include geo-fence information. The geo-fence information may include information about an emergency alert message transmission area and an emergency alert message display area.

In operation 215, the mobile communication network gateway 203 may transmit the request message to the base station 204. In addition, the mobile communication network gateway 203 may transmit, to the electronic device 202, a confirmation message indicating that the request message has been received, and the electronic device 202 that has received the confirmation message may transmit the confirmation message to the emergency alert message transmission server 201.

In operation 217, the base station 204 may transmit the emergency alert message to the terminal 205.

Operations 211 to 217 may be included in an emergency alert message request process. A trigger process may be performed after the emergency alert message request process. Operations 219 to 221 may be included in the trigger process.

In operation 219, the electronic device 202 may transmit a trigger request message to the mobile communication network gateway 203. The trigger request message may be a message for the base station 204 to repeatedly transmit the trigger message to the terminal 205. The trigger message may be a message for the terminal 205 to display the emergency alert message on a screen of the terminal 205.

In operation 221, the mobile communication network gateway 203 may transmit the trigger request message to the base station 204. The mobile communication network gateway 203 that has received the trigger request message from the electronic device 202 may transmit, to the electronic device 202, a confirmation message that the trigger request message has been received.

In operation 223, the base station 204 may transmit the trigger message to the terminal 205. The base station 204 may repeatedly transmit the trigger message. Repeatedly transmitting the trigger message may be referred to as a trigger message transmission process.

The base station 204 may repeatedly transmit the trigger message to the terminal 205 based on the transmission period information of the trigger message and the transmission number information of the trigger message included in the trigger request message. The base station 204 may wait according to the transmission period information of the trigger message and then may transmit the trigger message again. The base station 204 may transmit the trigger message by as many times as the transmission number information of the trigger message. In other words, the base station 204 may transmit the trigger message, may wait for a period according to the transmission period information, and then may transmit the trigger message again. This operation may be repeated by as many times as the transmission number information.

When the terminal 205 receives the trigger message, the terminal 205 may determine whether to display the emergency alert message based on the geo-fence information included in the emergency alert message.

In operation 225, when the trigger message no longer needs to be transmitted to the terminal 205, the emergency alert message transmission server 201 may transmit a trigger stop message to the electronic device 202.

In operation 227, the electronic device 202 may transmit the trigger stop message to the mobile communication network gateway 203.

In operation 229, the mobile communication network gateway 203 may transmit the trigger stop message to the base station 204.

Operations 225 to 229 may be referred to as a trigger stop process.

In response to receiving the trigger stop message, the base station 204 may transmit a trigger stop response message to the mobile communication network gateway 203 in response. The trigger stop response message may be transmitted to the emergency alert message transmission server 201 through the mobile communication network gateway 203 and the electronic device 202.

The base station 204 that has received the trigger stop message may stop transmitting the trigger message even if the base station 204 has not transmitted the trigger message to the terminal 205 by as many times as the transmission number information.

Hereinafter, an emergency alert message transmission area and an emergency alert message display area are described.

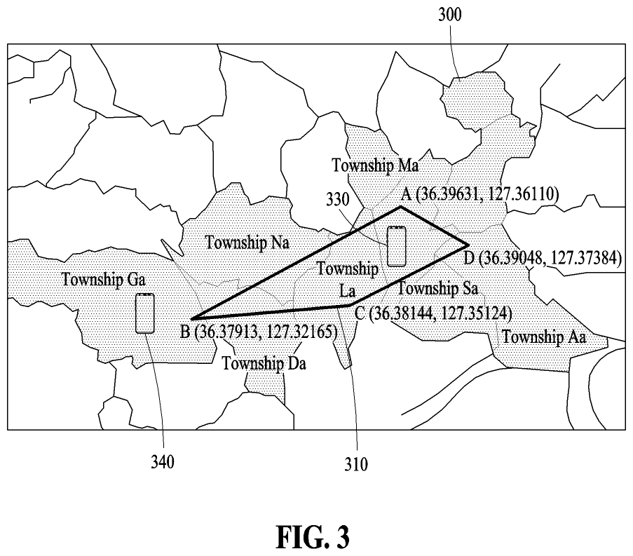

FIG. 3 is a diagram illustrating an emergency alert message transmission area and an emergency alert message display area according to an embodiment.

Referring to FIG. 3, an emergency alert message transmission area 300 and an emergency alert message display area 310 are shown. The emergency alert message transmission area 300 may refer to an area to which an emergency alert message is to be transmitted. Accordingly, terminals located within the emergency alert message transmission area 300 may receive the emergency alert message. The emergency alert message transmission area 300 may be determined based on administrative districts. For example, the emergency alert message transmission area 300 may include township Ga or township Na.

Terminals located within the emergency alert message display area 310 may display the emergency alert message on a screen. The emergency alert message display area 310 may be a circle or a polygon. The emergency alert message display area 310 may be determined using vertex coordinates. For example, the emergency alert message display area 310 may be determined as points A to D.

Geo-fence information may include information about the emergency alert message transmission area 300 and the emergency alert message display area 310. The information about the emergency alert message display area 310 may be the vertex coordinates of the emergency alert message display area 310.

A terminal 330 may be located within the emergency alert message transmission area 300 and within the emergency alert message display area 310. Accordingly, when the terminal 330 receives the emergency alert message, the terminal 330 may display the emergency alert message on the screen. A terminal 340 may be located within the emergency alert message transmission area 300 but may not be located within the emergency alert message display area 310. Accordingly, the terminal 340 may receive the emergency alert message but may not display the emergency alert message on the screen. When the emergency alert message is received, even if the terminal 340 is located within the emergency alert message transmission area 300 but not within the emergency alert message display area 310, the terminal 340 may display the emergency alert message on the screen when the terminal 340 is located within the emergency alert message display area 310 when a trigger message is received.

The emergency alert message may be transmitted by separating the emergency alert message transmission area 300 and the emergency alert message display area 310, and thus, duplicate reception of emergency alert messages and reception of emergency alert messages in an excessive range may be prevented.

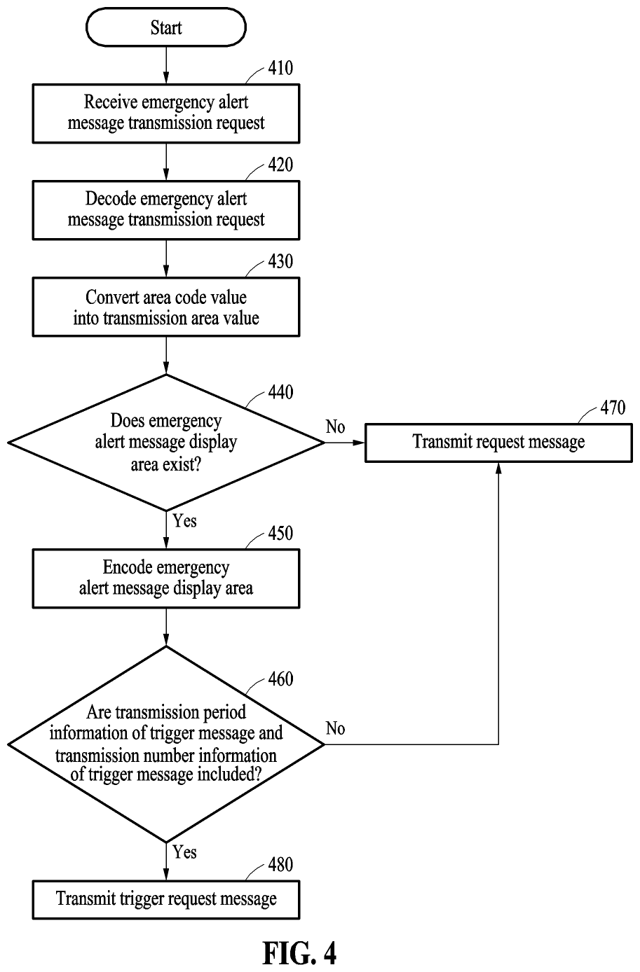

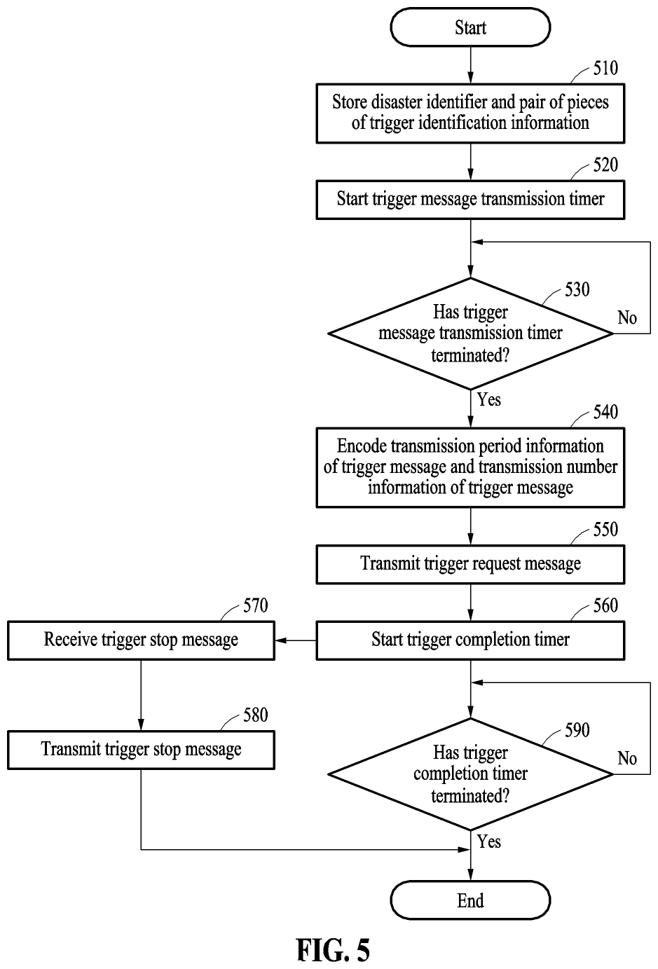

FIGS. 4 and 5 are flowcharts illustrating a method of operating an electronic device, according to an embodiment.

Referring to FIG. 4, the flowchart illustrates operations from receiving of an emergency alert message transmission request by an electronic device to transmitting a trigger request message.

Operations to be described hereinafter may be performed sequentially but not necessarily. For example, the order of the operations may change and at least two of the operations may be performed in parallel. Operations may be performed by any one of components of an electronic device.

In operation 410, the electronic device may receive an emergency alert message transmission request from an emergency alert message transmission server.

In operation 420, the electronic device may decode the emergency alert message transmission request.

The electronic device may decode the emergency alert message transmission request to obtain at least one of geo-fence information, transmission period information of a trigger message, and transmission number information of the trigger message. The geo-fence information may include information about an emergency alert message display area and information about an emergency alert message transmission area.

In operation 430, the electronic device may convert an area code value into a transmission area value. The area code value may be a code value indicating the emergency alert message transmission area. The electronic device may convert the area code value into the transmission area value according to mapping information requested by mobile communication service providers.

In operation 440, the electronic device may determine whether the emergency alert message display area exists in a transmission area corresponding to the transmission area value.

In other words, the electronic device may determine whether a polygon or circle exists in the transmission area corresponding to the transmission area value.

When the emergency alert message display area does not exist in the transmission area, operation 470 may be performed. When the emergency alert message display area exists in the transmission area, operation 450 may be performed.

In operation 450, the electronic device may encode the emergency alert message display area in a request message.

In operation 460, the electronic device may determine whether the decoded emergency alert message transmission request includes the transmission period information of the trigger message and the transmission number information of the trigger message.

When the transmission period information of the trigger message and the transmission number information of the trigger message are not included, operation 470 may be performed. When the transmission period information of the trigger message and the transmission number information of the trigger message are included, operation 480 may be performed.

In operation 470, the electronic device may transmit the request message to a mobile communication network gateway. Here, the electronic device may not perform a trigger process.

In operation 480, the electronic device may transmit a trigger request message. In other words, the trigger process may be performed.

Referring to FIG. 5, the flowchart illustrates a method of transmitting a trigger message.

Operations to be described hereinafter may be performed sequentially but not necessarily. For example, the order of the operations may change and at least two of the operations may be performed in parallel. Operations may be performed by any one of components of an electronic device.

In operation 510, the electronic device may store a pair of pieces of trigger identification information. The pair of pieces of trigger identification information may be expressed as Table 1 below. The pair of pieces of trigger identification information may refer to a pair of a disaster identifier and message serial number. An event identifier may be used to manage the pair of pieces of trigger identification information.

TABLE 1

| Identifier | Type of Disaster | Message Number |
|---|---|---|
| Event Identifier | Disaster identifier | Message serial number |
| | (Message Identifier) | (Serial number) |

In operation 520, the electronic device may start a trigger message transmission timer. The trigger message transmission timer may be a timer for a time interval from the transmitting of the request message by the electronic device to the transmitting of the trigger request message. In addition, the trigger message transmission timer may also be used for a retransmission period in which a base station transmits the trigger message to a terminal. The trigger message transmission timer may be determined differently depending on the type of disaster.

In operation 530, the electronic device may determine whether the trigger message transmission timer has terminated. When the trigger message transmission timer has terminated, operation 540 may be performed.

In operation 540, the electronic device may encode the transmission period information of the trigger message and the transmission number information of the trigger message into a trigger request message. The transmission period information of the trigger message and the transmission number information of the trigger message may be included in the emergency alert message transmission request received in operation 410 of FIG. 4.

In operation 550, the electronic device may transmit the trigger request message to the mobile communication network gateway.

In operation 560, the electronic device may start a trigger completion timer.

The trigger completion timer may indicate the time at which the base station completes transmission of the trigger message by as many times as the number of transmissions.

In operation 570, the electronic device may determine whether the trigger completion timer has terminated. When the trigger completion timer has terminated, the base station may no longer transmit the trigger message to the terminal.

According to an embodiment, even if the trigger completion timer has not terminated, the electronic device may stop transmitting the trigger message when the electronic device receives a trigger completion message.

In operation 570, the electronic device may receive a trigger stop message from the emergency alert message transmission server 201. The trigger stop message may be a message to stop transmitting the trigger message. According to an embodiment, the trigger stop message may be transmitted from the emergency alert message transmission server to the electronic device when the disaster situation has ended.

In operation 580, the electronic device may transmit the trigger stop message to the mobile communication network gateway.

The mobile communication network gateway may transmit the trigger stop message to the base station, and when the base station receives the trigger stop message, the base station may stop transmitting the trigger message. In other words, when the trigger stop message is received, the base station may no longer transmit the trigger message to the terminal, even if the base station has not transmitted the trigger message by as many times as the transmission number information to the terminal.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The method according to embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, for example, a computer program tangibly embodied in a machine readable storage device (a computer-readable medium) to process the operations of a data processing device, for example, a programmable processor, a computer, or a plurality of computers or to control the operations. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read-only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific embodiments, the details should not be construed as limiting any invention or a scope that can be claimed, but rather should be construed as being descriptions of features that may be peculiar to specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate sub-combination. Moreover, although features may be described above as acting in specific combinations and even initially claimed as such, one or more features from a claimed combination can in some cases be excised from the combination, and the claimed combination may be changed to a sub-combination or a modification of a sub-combination.

Likewise, although operations are depicted in a predetermined order in the drawings, it should not be construed that the operations need to be performed sequentially or in the predetermined order, which is illustrated to obtain a desirable result, or that all of the shown operations need to be performed. In specific cases, multitasking and parallel processing May be advantageous. In addition, it should not be construed that the separation of various device components of the aforementioned embodiments is required in all types of embodiments, and it should be understood that the described program components and devices are generally integrated as a single software product or packaged into a multiple-software product.

The embodiments disclosed in the present specification and the drawings are intended merely to present specific examples in order to aid in understanding of the present disclosure, but are not intended to limit the scope of the present disclosure. It will be apparent to one of ordinary skill in the art that various modifications based on the technical spirit of the present disclosure, as well as the disclosed embodiments, can be made.

What is claimed is:

1. A method of operating an electronic device, the method comprising:
receiving an emergency alert message transmission request from a server;
in response to the emergency alert message transmission request, transmitting, to a mobile communication network gateway, a request message for requesting a base station to transmit an emergency alert message to a terminal; and
transmitting, to the mobile communication network gateway, a trigger request message for causing the base station to repeatedly transmit a trigger message to the terminal to attempt to display the emergency alert message on a screen of the terminal,
wherein the emergency alert message transmission request comprises geo-fence information, transmission period information of the trigger message, and transmission number information of the trigger message.

2. The method of claim 1, wherein
the transmitting of the request message to the mobile communication network gateway comprises:
converting an area code value included in the emergency alert message transmission request into a transmission area value of a mobile communication service provider, based on mapping information requested by the mobile communication service provider; and
determining whether an emergency alert message display area exists in a transmission area corresponding to the transmission area value.

3. The method of claim 2, wherein
the transmitting of the trigger request message to the mobile communication network gateway comprises, when the emergency alert message display area does not exist, not transmitting the trigger request message to the mobile communication network gateway.

4. The method of claim 2, wherein
the transmitting of the request message to the mobile communication network gateway further comprises determining whether the emergency alert message transmission request includes the transmission period information of the trigger message and the transmission number information of the trigger message.

5. The method of claim 4, wherein
the transmitting of the trigger request message to the mobile communication network gateway comprises, when the emergency alert message transmission request does not include at least one of the transmission period information of the trigger message or the transmission number information of the trigger message, not transmitting the trigger request message to the mobile communication network gateway.

6. The method of claim 1, wherein
the terminal does not display the emergency alert message on the screen of the terminal, when the terminal is located within an emergency alert message transmission area but not within an emergency alert message display area.

7. The method of claim 6, wherein,
when the emergency alert message is received, even if the terminal is located within the emergency alert message transmission area but not within the emergency alert message display area, the terminal displays the emergency alert message on the screen of the terminal when the terminal is located within the emergency alert message display area when the trigger message is received.

8. The method of claim 1, wherein
the base station repeatedly transmits the trigger message to the terminal based on the transmission period information of the trigger message and the transmission number information of the trigger message.

9. A method of operating a terminal, the method comprising:
receiving an emergency alert message from a base station;
determining whether to display the emergency alert message on a screen based on an emergency alert message display area included in the emergency alert message; and
determining whether to display the emergency alert message on the screen by repeatedly receiving a trigger message from the base station,
wherein the base station transmits, to the terminal, the emergency alert message transmitted from an electronic device that has received an emergency alert message transmission request to the terminal, and
wherein the emergency alert message transmission request comprises geo-fence information, transmission period information of the trigger message, and transmission number information of the trigger message.

10. The method of claim 9, wherein
the determining of whether to display the emergency alert message on a screen based on an emergency alert message display area included in the emergency alert message comprises, when the terminal is located within an emergency alert message transmission area but not within an emergency alert message display area, not displaying the emergency alert message on the screen of the terminal.

11. The method of claim 9, wherein
the determining of whether to display the emergency alert message on the screen by repeatedly receiving a trigger message from the base station comprises, when the emergency alert message is received, even if the terminal is located within the emergency alert message transmission area but not within the emergency alert message display area, displaying the emergency alert message on the screen of the terminal when the terminal is located within the emergency alert message display area when the trigger message is received.

12. An electronic device comprising:
a memory; and
a processor,
wherein the processor is configured to:
receive an emergency alert message transmission request from a server;
in response to the emergency alert message transmission request, transmit, to a mobile communication network gateway, a request message for requesting a base station to transmit an emergency alert message to a terminal; and
transmit, to the mobile communication network gateway, a trigger request message for causing the base station to repeatedly transmit a trigger message to the terminal to attempt to display the emergency alert message on a screen of the terminal,
wherein the emergency alert message transmission request comprises geo-fence information, transmission period information of the trigger message, and transmission number information of the trigger message.

13. The electronic device of claim 12, wherein
the processor is further configured to:
convert an area code value included in the emergency alert message transmission request into a transmission area value of a mobile communication service provider, based on mapping information requested by the mobile communication service provider; and
determine whether an emergency alert message display area exists in a transmission area corresponding to the transmission area value.

14. The electronic device of claim 13, wherein
the processor is further configured not to transmit the trigger request message to the mobile communication network gateway when the emergency alert message display area does not exist.

15. The electronic device of claim 13, wherein
the processor is further configured to determine whether the emergency alert message transmission request includes the transmission period information of the trigger message and the transmission number information of the trigger message.

16. The electronic device of claim 15, wherein
the processor is further configured not to transmit the trigger request message to the mobile communication network gateway when the emergency alert message transmission request does not include at least one of the transmission period information of the trigger message or the transmission number information of the trigger message.

17. The electronic device of claim 12, wherein
the terminal does not display the emergency alert message on the screen of the terminal, when the terminal is located within an emergency alert message transmission area but not within an emergency alert message display area.

18. The electronic device of claim 17, wherein,
when the emergency alert message is received, even if the terminal is located within the emergency alert message transmission area but not within the emergency alert message display area, the terminal displays the emergency alert message on the screen of the terminal when the terminal is located within the emergency alert message display area when the trigger message is received.

19. The electronic device of claim 12, wherein
the base station repeatedly transmits the trigger message to the terminal based on the transmission period information of the trigger message and the transmission number information of the trigger message.
